(19) United States
(12) Patent Application Publication
(10) Pub. No.: US 2013/0171351 A1
(43) Pub. Date: Jul. 4, 2013

(54) VACUUM TABLE FOR A PRINTING DEVICE

(71) Applicants: Uri Vekstein, Haifa (IL); Tzachi Pressburger, Kfar Horesh (IL)

(72) Inventors: Uri Vekstein, Haifa (IL); Tzachi Pressburger, Kfar Horesh (IL)

(73) Assignee: CAMTEK LTD., Migdal Haemek (IL)

(21) Appl. No.: 13/549,559

(22) Filed: Jul. 16, 2012

Related U.S. Application Data
(60) Provisional application No. 61/508,757, filed on Jul. 18, 2011.

(51) Int. Cl. B05C 13/00

(52) U.S. Cl. CPC B05C 13/00
USPC 427/256; 118/300; 118/712

(57) ABSTRACT

A system that may include a printing module arranged to print patterns on a substrate by inkjetting ink on the substrate; and a substrate supporting module that comprises: a porous material module for supporting the substrate and providing vacuum to multiple locations of the substrate when the substrate is placed on a flat upper surface of the porous material module; and an interface module that comprises: at least one inlet for receiving vacuum from a vacuum system; at least one outlet for providing the vacuum to the porous material module; and at least one structural element arranged to contact the porous material module and provide mechanical support to the porous material module.

### RELATED APPLICATIONS

This application claims the priority of U.S. provisional patent Ser. No. 61/508757 filing date Jul. 18 2011 which is incorporated herein by reference.

### BACKGROUND OF THE INVENTION

Various layers of printed circuit boards or other large substrates can be printed by one or more print heads of a printing device. The printing process must be accurate.

Once printing starts, any motion of the substrate must be strictly controlled by the printing mechanism. Any random motion of the substrate not initiated or controlled by the printing mechanism will result in random placement of the printed material causing unacceptable inaccuracies.

When the substrate has features prior to printing and the printing has to be synchronized with said features, accuracy is ensured by using an alignment mechanism which may include imaging and analysis of said features on the substrate. The position of said features on the substrate relative to the respective ones on a reference image is used to align the printing heads and operate them in the required position to deposit the printing material. In order for this process to succeed, it is essential to avoid any motion of the substrate between the imaging step and the printing step. Any such motion would void the results of the alignment process and the required accuracy would not be achieved.

Furthermore, in an inkjet printing system, the surface of the target substrate must be kept at an even distance from the printing heads throughout the printing area and process. Any height changes would result in lateral misplacement of the printing material on the substrate, again, causing unacceptable inaccuracies.

Accordingly—during the printing process it is required to secure the substrate in order to avoid both print height change and panel shift.

This requirement, together with the physical properties of the PCB, usually forces most designers to select vacuum methods for securing the substrates.

A vacuum solution usually has a level surface (plate) with holes of various diameters somewhat distributed over the surface for the application of vacuum to apply an attraction force between the plate and the substrate above it.

Vacuum is supplied to the plate using a vacuum source, possibly a pump, and is conducted to the holes on the surface.

Yet, copper traces on the lower surface of the substrate (the one in contact with the vacuum plate) may be of various thicknesses and may create air channels between the plate and the substrate through which the vacuum can “escape” thus reducing its effectiveness.

In addition to that, a substrate may include numerous thru holes and openings, causing further vacuum loss and making the vacuum requirements even tougher. To compensate for all this vacuum loss, the vacuum flow must be increased. Some of this flow inevitably escapes through said thru holes to the upper surface of the substrate in the form of air flow into said substrate. When the vacuum hole and a thru hole are sufficiently close to each other, this flow may be substantial and has a very detrimental side effect when printing with inkjet on the substrate: inkjet drops from the print heads that are directed towards the substrate near thru holes, can be influenced by the air flowing through the holes, thereby, being misplaced on the substrate.

In other words the vacuum can influence the inkjet drop “flight profile” and cause inkjet drop to arrive at an erroneous landing point on the substrate.

Furthermore, the ink, after being printed on the substrate is not yet cured, and, being fluid, may even flow through the thru hole openings to the other side of the substrate contaminating it.

### SUMMARY OF THE INVENTION

According to an embodiment of the invention there is provided a system that may include (a) a printing module arranged to print patterns on a substrate by inkjetting ink on the substrate; and (b) a substrate supporting module (such as a vacuum table) that may include: (b1) a porous material module (such as a porous plate) for supporting the substrate and providing vacuum to multiple locations of the substrate when the substrate is placed on a flat upper surface of the porous material module; and (b2) an interface module that may include (i) at least one inlet for receiving vacuum from a vacuum system, (ii) at least one outlet for providing the vacuum to the porous material module; and (iii) at least one structural element arranged to contact the porous material module and provide mechanical support to the porous material module.

The porous material module may provide numerous passages for vacuum propagation. The porous nature of the porous material allows the spreading of vacuum over a large surface, providing a strong holding force, without generating substantial directional flow through anyone of the pores.

The system may generate sufficient vacuum force to hold a substrate motionless without generating detrimental air flow through passages between the two surfaces of said substrate.

The interface module may be made of a material that is more durable then a porous material of the porous material module. Thus, the interface module can receive vacuum ports or otherwise interface in a reliable manner with outlets or ports of a vacuum system. Furthermore, the interface module can be attached to a mechanical stage that may move the substrate supporting module and can withstand forces induced during that movement.

The porous material module is made of a porous material that has microscopic scale pores. The size of the pores can be less than a micron, one or few microns, few tens microns or few hundred microns.

The substrate supporting module may include multiple porous material modules. And the flat upper surfaces of the multiple porous material modules may be located at a same plane in order to support the same substrate.

The multiple porous material modules may be proximate to each other—the distance between adjacent porous material modules may be smaller than the width or length of any of the porous material modules.

The substrate supporting module may be configured to support substrates of different shapes and sizes; wherein different combinations of porous material modules firs substrates of different shapes and sizes.

The porous material module and the interface module, when put together, define at least one inner space that interfaces between the at least one outlet of the interface module and a lower surface of the porous material module.

The at least one inner space spans along a majority of the lower surface of the porous material.

The one or more structural elements of the interface module are located within the at least one inner spaces.

The porous material module and the interface module, when put together, define multiple inner spaces, wherein the multiple inner spaces interface between the at least one outlet of the interface module and multiple areas of a lower surface of the porous material module; wherein the interface module comprises vacuum control components for independently selecting a provision of vacuum to at least two of the multiple inner spaces.

The substrate supporting module may include at least one vacuum measurement unit.

Vacuum may be generated by various means including but not limited to vacuum pumps.

The porous material module may be a vacuum plate.

Vacuum may be supplied to the vacuum plate by various means including but not limited to zero or more pipes.

The vacuum plate may be of various regular or irregular shapes including but not limited to a rectangular prism.

Said vacuum plate may have zero or more chambers for accumulating vacuum.

Said chambers may be activated together or individually and may be blocked together or individually.

Said vacuum plate may have zero or more passages for the vacuum to be channeled to said porous material.

Said passages may be activated together or individually and may be blocked together or individually.

The porous material form which porous material module may be of various shapes including but not limited to a rectangular prism.

Said porous material can be made from materials such as but not limited to commercially available porous ceramics, porous aluminum etc.

The pores in the porous material channeling the vacuum from one side to the other may be of various geometries including but not limited to regular or irregular passages, labyrinths, each of which may be of but is not limited to microscopic (micronic) dimensions.

Air flow through said pores may be directional or non-directional. Air may flow into each of said pores in random directions.

A method may be provided for manufacturing said vacuum table.

Said method may include but is not limited to separately manufacturing the vacuum plate, the porous material and attaching the various parts prior to assembling in a printing system.

Said method may include but is not limited to separately manufacturing the vacuum plate, the porous material and attaching the various parts separately in a printing system.

Said method may include but is not limited to replacing the porous material on a printing system when required.

A method may be provided for using said vacuum table on a printing system.

Said method may include but is not limited to switching the vacuum on or off manually or using automated means.

Said method may include but is not limited to controlling the amount of vacuum supplied to said vacuum table manually or using automated means,

The method may include but is not limited to providing vacuum to selected portions of said vacuum table manually or using automated means.

Said automated means may include but is not limited to electrical, pneumatic, hydraulic switches, air flow controllers, electronic control systems, computers, computer programs.

Said method may include but is not limited to measuring air flow into said external porous surface of said vacuum table, out of said vacuum table, internal passages in said vacuum table etc.

Said method may include but is not limited to using the measurements to control vacuum supplied to the vacuum table, to switch and control the areas receiving vacuum in said vacuum table, to regulate air flow into said porous surface.

Said method may include but is not limited to synchronizing vacuum flow inside said vacuum table with the position of the print heads ejecting ink drops towards the substrate within the scope of a printing system.

According to an embodiment of an invention there may be provided a method for utilizing any of the systems illustrated in the specification. The method may include providing structural support to a porous material module of a substrate supporting module by an intermediate module of the substrate supporting module; placing the substrate on a flat upper surface of the porous material module; receiving vacuum via at least one inlet of the intermediate module; providing the vacuum to at least a lower surface of the porous material module; and providing the vacuum to multiple locations of the substrate via the flat upper surface of the porous material module.

The-re may be provided a method for printing on a substrate, the method may include: providing structural support to a porous material module of a substrate supporting module by an intermediate module of the substrate supporting module; placing the substrate on a flat upper surface of the porous material module; receiving vacuum via at least one inlet of the intermediate module; providing the vacuum to at least a lower surface of the porous material module; providing the vacuum to multiple locations of the substrate via the flat upper surface of the porous material module; and printing on the substrate by inkjetting ink on the substrate.

### BRIEF DESCRIPTION OF THE DRAWINGS

Further details, aspects and embodiments of the invention will be described, by way of example only, with reference to the drawings. In the drawings, like reference numbers are used to identify like or functionally similar elements. Elements in the figures are illustrated for simplicity and clarity and have not necessarily been drawn to scale.

FIGS. 1A-1D are cross sectional view of substrate supporting modules such as a vacuum plate according to various embodiments of the invention;

FIG. 2 illustrates a substrate that is supported by a substrate supporting module according to an embodiment of the invention;

FIG. 3 illustrates multiple substrates that are supported by multiple porous material modules of a substrate supporting module according to an embodiment of the invention;

FIGS. 4A-4C are top views of interface modules according to various embodiments of the invention;

FIG. 5 is a cross sectional view of substrate supporting modules such as a vacuum plate according to an embodiment of the invention;

FIG. 6 illustrates a system according to an embodiment of the invention; and

FIG. 7 illustrates a method according to an embodiment of the invention.

### DETAILED DESCRIPTION OF THE DRAWINGS

The foregoing and other objects, features, and advantages of the present invention will become more apparent from the following detailed description when taken in conjunction with the accompanying drawings. In the drawings, similar reference characters denote similar elements throughout the different views.

Because the illustrated embodiments of the present invention may for the most part, be implemented using electronic components and circuits known to those skilled in the art, details will not be explained in any greater extent than that considered necessary for the understanding and appreciation of the underlying concepts of the present invention and in order not to obfuscate or distract from the teachings of the present invention.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

According to an embodiment of the invention a porous vacuum table is provided. It has multiple small holes that are positioned at the top portion of the vacuum table and allow air to be sucked in order to maintain a desired vacuum near the substrate.

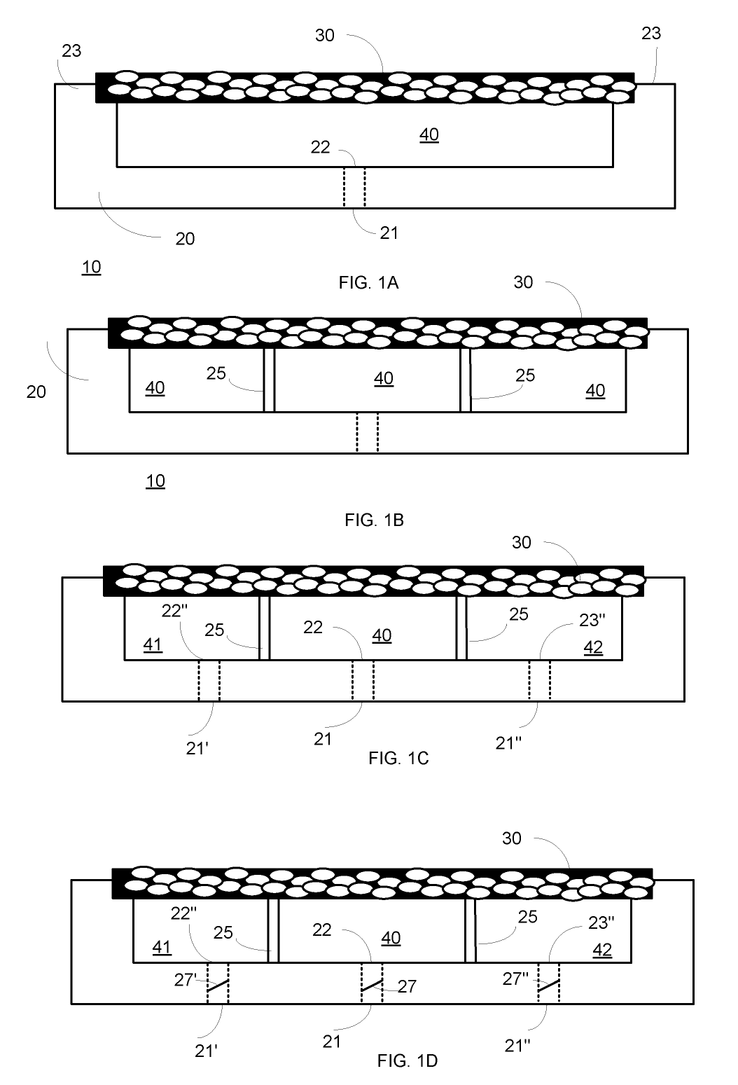

FIGS. 1A-1D are cross sectional views of a substrate supporting modules 10 according to various embodiments of the invention.

FIG. 1A illustrates a substrate supporting module 10 that includes a porous material module 30 for supporting the substrate and providing vacuum to multiple locations of the substrate when the substrate is placed on a flat upper surface of the porous material module; and an interface module 20 that includes an inlet 21 for receiving vacuum from a vacuum system; an outlet 22 for providing the vacuum to the porous material module 20 (or—in the case of FIG. 1A for providing vacuum to the porous material module 20 via inner space 40); and at least one structural element such as shoulders 23 arranged to contact the porous material module 20 and provide mechanical support to the porous material module 20.

The interface module 20 is made of a material (such as stainless steel) that is more durable then a porous material of the porous material module 30.

The porous material module 20 may be made of a porous material that has microscopic scale pores.

FIG. 1A illustrates that the porous material module 30 and the interface module 20, when put together, define an inner space 40 that interfaces between the at least one outlet (such as outlet 22) of the interface module 20 and a lower surface of the porous material module 30.

FIG. 1A illustrates that the inner space spans along a majority of the lower surface of the porous material 30.

The structural elements of the interface module may be located within the at least one inner spaces defined by the interface module 20 and the porous material module 30. FIG. 1B illustrates a pair of supporting elements 25 that are located within the inner space 40 but not partition the inner space 40 to multiple separate inner spaces.

FIG. 1C illustrates a pair supporting elements 25 that partition the inner space to multiple inner spaces 40, 41 and 42 that are separated for each other. FIG. 1C also illustrates three vacuum passageways 21, 21′ and 21″ formed in the interface module 20 that directly contacts the entire lower surface of the porous material module 30.

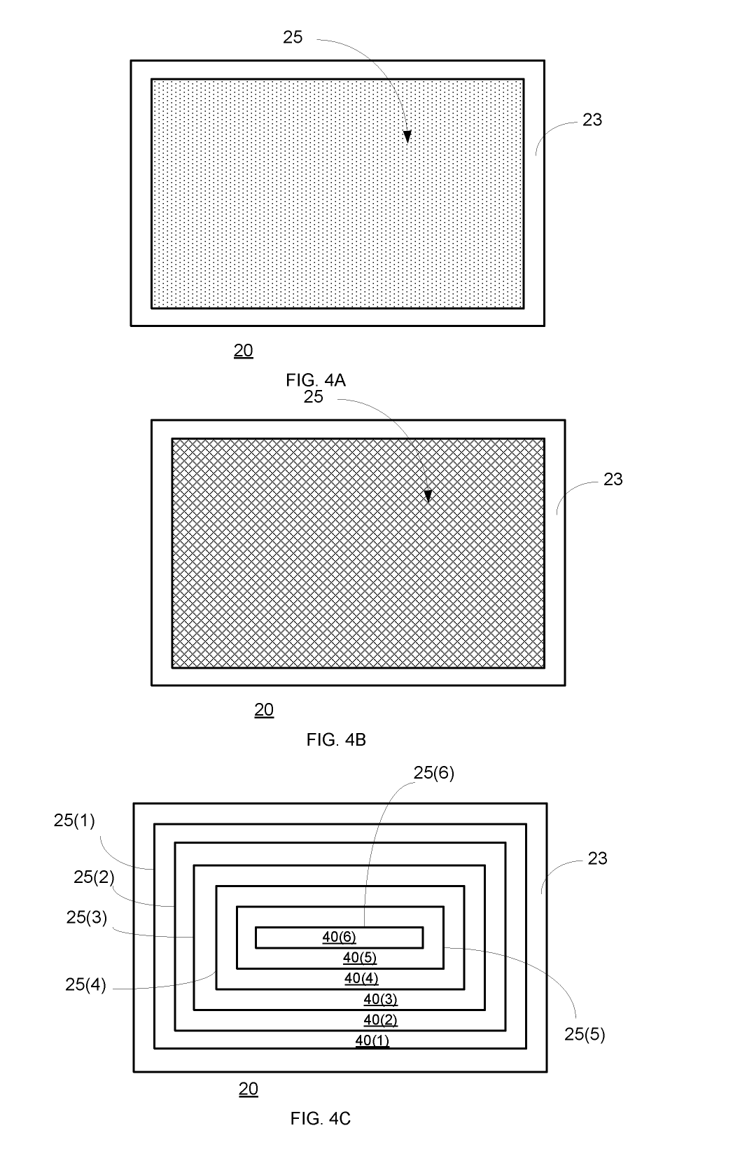

The supporting elements may differ from each other, may have the same size and shape or different sizes and shapes. For example, FIG. 4A is a top view of the interface module 20 and illustrates an array of spaced apart cylindrical supporting elements 25, FIG. 4B illustrates a grid of supporting elements that are shaped as bars while FIG. 4C illustrates rectangular shaped supporting element 25(1)-25(6) that partition the inner space to inner spaces 40(1)-40(6). Other non-limiting examples of supporting elements may include ring shaped (concentric or not) structural elements, radially extending support elements and the like.

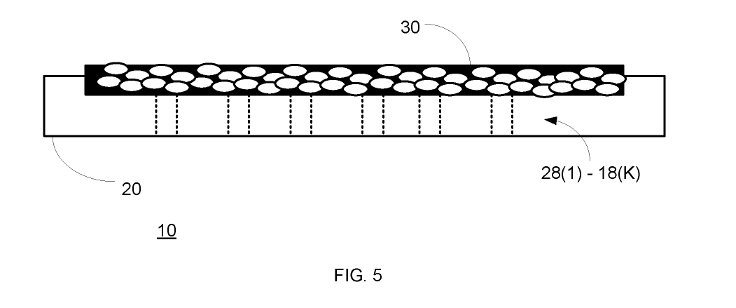

Whenever there are multiple inner spaces the vacuum to each inner space (or to each group of inner spaces) can be controlled independently. Thus may allow preventing vacuum supply to an inner space that is not covered by the substrate. The same vacuum control scheme can be applied in cases where there is no inner space and the porous material module is positioned on the intermediate element—as illustrated in FIG. 5—multiple vacuum passageways 28(1)-28(1) are formed in the interfacing element 20 that directly contacts the entire lower surface of the porous material module 30.

FIG. 1D illustrates multiple vacuum control components 26, 26′ and 26″, such as valves, each control he provision of vacuum to one of inner spaces 40, 41 and 42 respectively.

FIG. 1D also illustrates three vacuum passageways 21, 21′ and 21″ formed in the interface module 20 that directly contacts the entire lower surface of the porous material module 30.

FIG. 1D also illustrates vacuum measurement units 27, 27′ and 27″ arranged to measure vacuum of inner spaces 40′ 41 and 42.

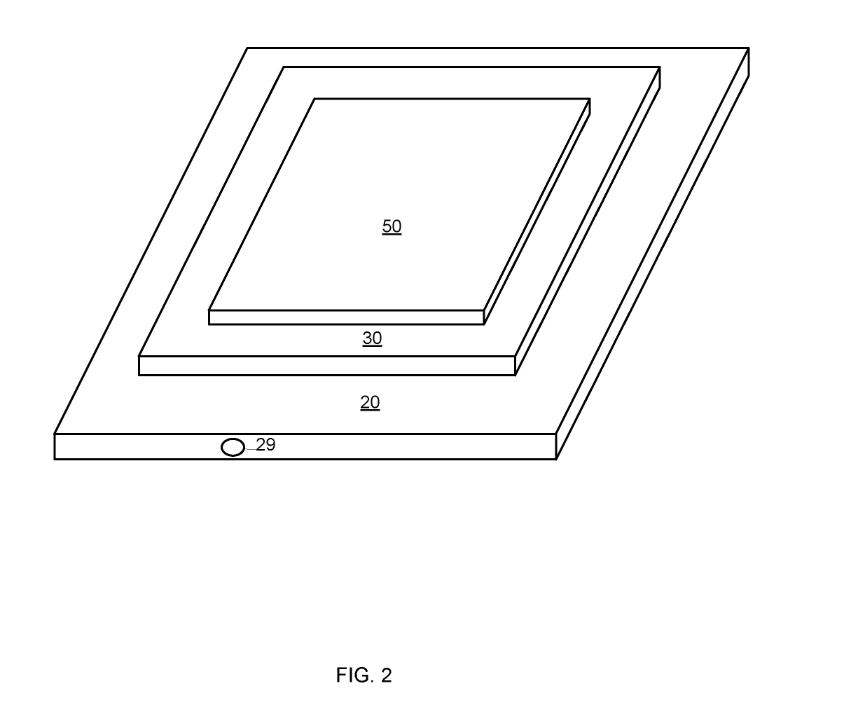

Although FIG. 1A-1D illustrate vacuum conduits that are located at the bottom surface of the interface module 20—FIG. 2 illustrates a vacuum inlet 29 that is formed in a sidewall of the interface module 20. FIG. 2 further illustrates substrate 50 and porous material module 30.

The interface module 20 can support multiple porous material modules. The flat upper surfaces of the multiple porous material modules may be located at a same plane.

The multiple porous material modules may be proximate to each other.

According to various embodiments of the invention the substrate supporting module may be configured to support substrates of different shapes and sizes. Different combinations of porous material modules may fit substrates of different shapes and sizes.

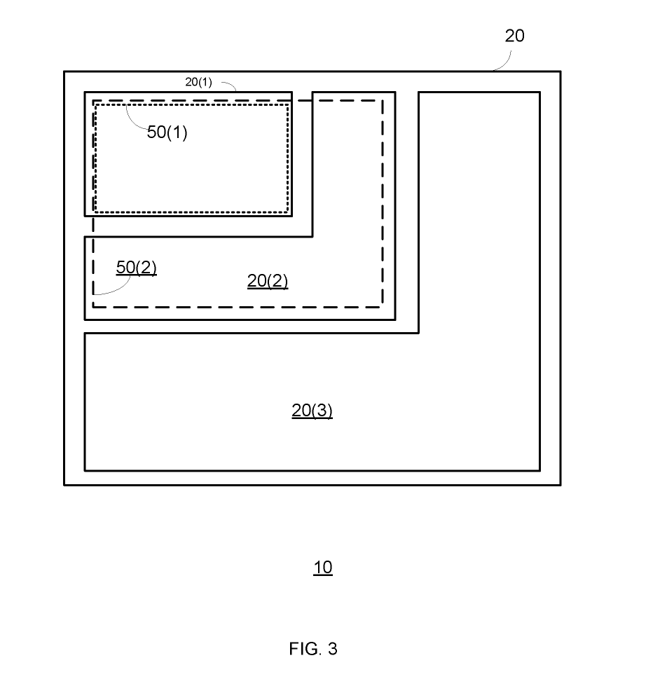

FIG. 3 illustrates an interface module 30 that supports a rectangular shaped porous material module 20(1) that may support substrate 50(1), a first inverted L shaped porous material module 20(2) and a second inverted L shaped porous material module 20(3), wherein the combination of porous material modules 20(1) and 20(2) supports substrate 50(2) and a combination of porous material modules 20(1)-20(3) supports substrate 50(3).

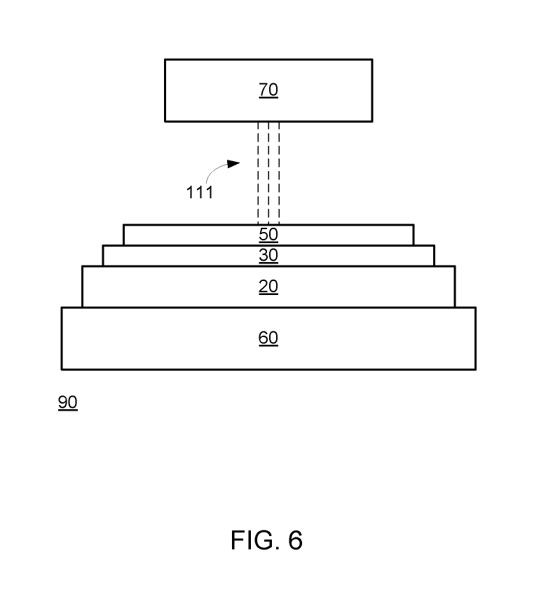

The substrate supporting module can be part of a printing system, as illustrated in FIG. 6. Referring to FIG. 6 there is provided a system that includes:
a. A printing module 70 that is arranged to print patterns on a substrate by inkjetting ink (illustrated by vertical dashed lines 111) on the substrate.
b. A substrate supporting module that includes:
   b.1. A porous material module 30 for supporting the substrate and providing vacuum to multiple locations of the substrate when the substrate is placed on a flat upper surface of the porous material module; and
   b.2. An interface module 20 that includes at least one inlet for receiving vacuum from a vacuum system; at least one outlet for providing the vacuum to the porous material module; and at least one structural element arranged to contact the porous material module and provide mechanical support to the porous material module.
c. A mechanical stage 60 arranged to move the substrate in relation to the printing module 70.

Ink drops are directed towards a substrate. The drops arrive from one or more print heads of the printing module that are located above the substrate.

The porous structure of the vacuum table allows high vacuum holding (high vacuum force) for substrates with thru holes and openings by reducing the vacuum loss through the openings. The multiple holes provide small air flows in multiple directions and do not form a vector of air that directly sucks the inkjet drops onto the other side of the substrate. A benefit of the porous plate is the non directional air flow vs. the directional air flow in any other solution.

Due to the low and non-directional air flow, the ink drops are not sucked through the substrate openings and therefore are not misplaced on the substrate. The top surface of the vacuum table=the porous material module—can be made from porous materials such as commercially available porous ceramics, porous aluminum, porous mix of various materials and the size of the porous can be also of micronic size.

According to an embodiment of the invention a method is provided. The method may include printing a pattern on a substrate that is supported by a porous vacuum table, while sucking air (in a non-directional manner) through the porous vacuum table. The printing may include directing ink jet drops towards the substrate.

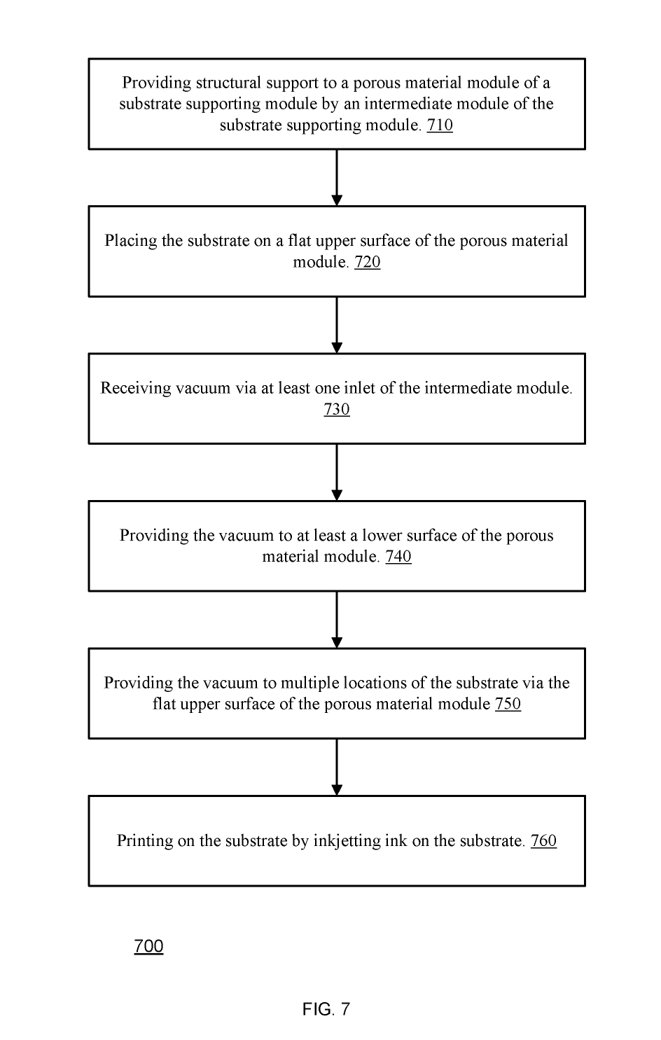

FIG. 7 illustrates a method 700 according to an embodiment of the invention.

Method 700 may start by stage 710 of providing structural support to a porous material module of a substrate supporting module by an intermediate module of the substrate supporting module.

Stage 710 may be followed by stages 720, 730, 740, and even by stage 750.

Stage 720 may include placing the substrate on a flat upper surface of the porous material module.

Stage 730 may include receiving vacuum via at least one inlet of the intermediate module.

Stage 740 may include providing the vacuum to at least a lower surface of the porous material module.

Stage 750 may include providing the vacuum to multiple locations of the substrate via the flat upper surface of the porous material module

Stage 760 may include printing on the substrate by inkjetting ink on the substrate. Stage 760 may include introducing a movement between the substrate and a printing module.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein can be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures can be implemented which achieve the same functionality.

Any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A system comprising:
a printing module arranged to print patterns on a substrate by inkjetting ink on the substrate; and
a substrate supporting module that comprises:
a porous material module for supporting the substrate and providing vacuum to multiple locations of the substrate when the substrate is placed on a flat upper surface of the porous material module; and an interface module that comprises:
at least one inlet for receiving vacuum from a vacuum system;
at least one outlet for providing the vacuum to the porous material module; and
at least one structural element arranged to contact the porous material module and provide mechanical support to the porous material module.

2. The system according to claim 1, wherein the interface module is made of a material that is more durable then a porous material of the porous material module.

3. The system according to claim 1, wherein the porous material module is made of a porous material that has microscopic scale pores.

4. The system according to claim 1, comprising multiple porous material modules.

5. The system according to claim 4, wherein flat upper surfaces of the multiple porous material modules are located at a same plane.

6. The system according to claim 4, wherein the multiple porous material modules are proximate to each other.

7. The system according to claim 4, wherein the substrate supporting module is configured to support substrates of different shapes and sizes; wherein different combinations of porous material modules firs substrates of different shapes and sizes.

8. The system according to claim 1, wherein the porous material module and the interface module, when put together, define at least one inner space that interfaces between the at least one outlet of the interface module and a lower surface of the porous material module.

9. The system according to claim 8, wherein the at least one inner space spans along a majority of the lower surface of the porous material.

10. The system according to claim 8, wherein one or more structural elements of the interface module are located within the at least one inner spaces.

11. The system according to claim 1, wherein the porous material module and the interface module, when put together, define multiple inner spaces, wherein the multiple inner spaces interface between the at least one outlet of the interface module and multiple areas of a lower surface of the porous material module; wherein the interface module comprises vacuum control components for independently selecting a provision of vacuum to at least two of the multiple inner spaces.

12. The system according to claim 1, comprising at least one vacuum measurement unit.

13. The system according to claim 1, wherein the interface module comprises multiple

14. A method for supporting a substrate, the method comprising:
providing structural support to a porous material module of a substrate supporting module by an intermediate module of the substrate supporting module;
placing the substrate on a flat upper surface of the porous material module;
receiving vacuum via at least one inlet of the intermediate module;
providing the vacuum to at least a lower surface of the porous material module;
providing the vacuum to multiple locations of the substrate via the flat upper surface of the porous material module; and
printing on the substrate by inkjetting ink on the substrate.
